(19) United States
(12) Patent Application Publication
(10) Pub. No.: US 2007/0131462 A1
(43) Pub. Date: Jun. 14, 2007

(54) Motor Control Apparatus For Pushed Or Pulled Article

(76) Inventor: Clive George Hemsley, Henley-On-Thames (GB)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/677,920

(22) Filed: Feb. 22, 2007

(30) Foreign Application Priority Data
Jun. 7, 2005 (GB) 0511526.6

(51) Int. Cl. B62D 51/04

(52) U.S. Cl. 180/19.3

(57) ABSTRACT

The invention relates to a control apparatus for an article such as a suitcase with motorized wheels and with a handle for pushing or pulling the article by the user. The apparatus has transducers to sense force applied to the handle pushing or pulling the article. The apparatus has control units connected to each transducer for controlling the speed of rotation of each motorized wheel. The control units increase the speed of rotation of the wheels when the handle is pulled, and the control units decrease the speed of rotation of the wheels when the handle is pushed.

The present invention relates to a control apparatus for a motorised article, especially motorised luggage.

Motorised articles such as electric golf carts are well known. These usually comprise a frame on which a golf bag is supported, and a pair of motorised wheels powered by a battery. The golf cart has a handle which can be held by a golfer whilst walking, and a hand operated controller is provided on the handle so that the speed of the cart can be controlled by the golfer depending on the speed the golfer wishes to walk at.

The invention seeks to provide a control apparatus for a motorised article in which the article adjusts its speed to the speed of the user rather than the user having to adjust the speed of the article. The invention is particularly applicable to a motorised suitcase such as described in co-pending patent application no. GB 0406156.0, the contents of which are hereby incorporated into this specification by reference.

According to the present invention there is provided a control apparatus for an article with at least one motorised wheel and with a handle for pushing or pulling the article by the user, said apparatus comprising:

a) at least one transducer to sense force applied to the handle pushing or pulling the article, and

b) at least one control unit connected to the or each transducer for controlling the speed of rotation of the or each motorised wheel, the or each control unit increasing the speed of rotation of the or each motorised wheel when the handle is pulled, and the or each control unit decreasing the speed of rotation of the or each motorised wheel when the handle is pushed.

Preferably the or each control unit controls the amount of electrical current delivered to the or each motorised wheel.

Preferably the article is a suitcase or other item of luggage.

Preferably the control apparatus comprises at least one speed sensor to sense the speed of rotation of each wheel. Preferably the or each speed sensor is connected to the or each control unit which prevents rotation of each wheel by a motor at a speed greater than a predetermined value. Preferably the or each speed sensor is a hall sensor.

Preferably the article supports two wheels each motorised by a respective motor. Preferably a control unit is provided for each wheel motor. Preferably a speed sensor is provided for each control unit.

Preferably the control units reduces the speed of the inside wheel as the article is turned to assist turning of the article. Preferably the control units sense through said speed sensors changes in wheel speed as the article is turned by a person with the handle, and then the control units reduces the speed of the inside wheel as the article is turned to assist turning of the article.

Preferably the article handle includes a horizontal handle bar and said at least one transducer comprises a pair of pressure transducers on said handle bar measuring rotational force applied to said handle when the article is pulled and pushed.

The control apparatus may further include a gyroscope connected to the control units whereby to balance the article on the or each wheel.

The invention also extends to an article comprising the above control apparatus.

Preferably the article comprises a handle which moves from a first stored position to a second in use position. Preferably the apparatus further includes a movement sensor to sense when the handle moves from the first to the second position and to activate the or each control unit. Preferably a latch is provided to releasably lock the handle in the first position, and said latch operates a switch to prevent operation of the apparatus when the handle is locked in the second position.

An embodiment of the invention will now be described with reference to the accompanying drawings in which:

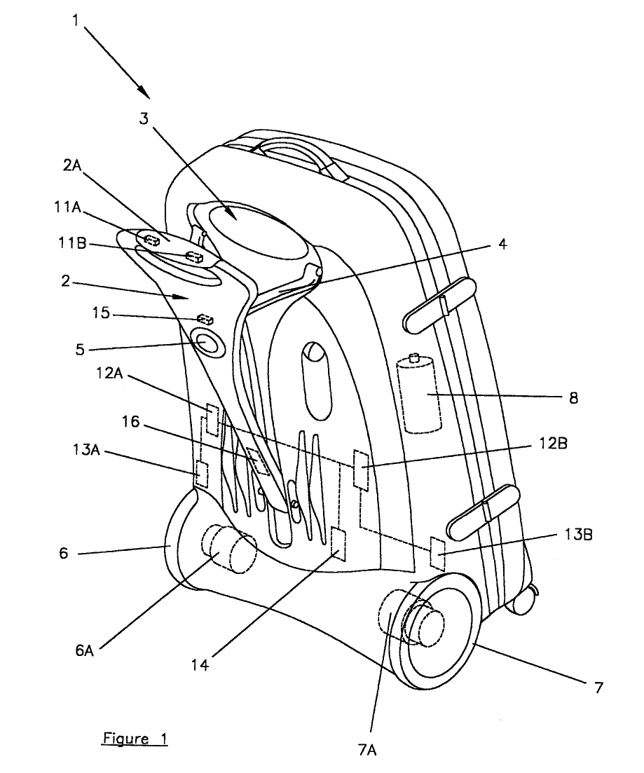

FIG. 1 shows a perspective view an article in the form of a suitcase with a control apparatus,

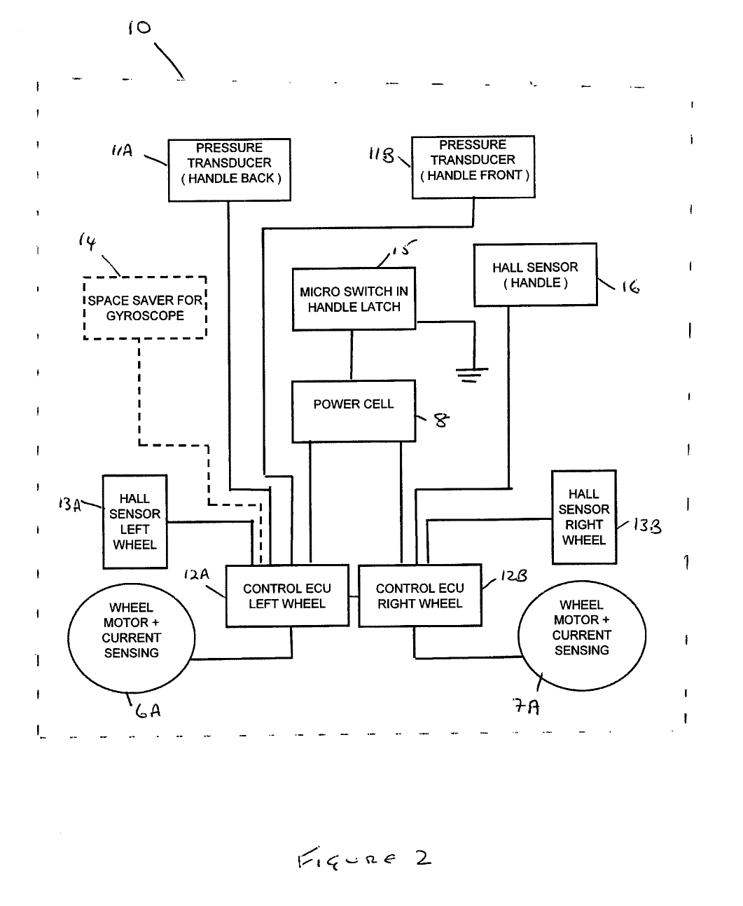

FIG. 2 shows a schematic circuit diagram.

Referring to FIG. 1 there is shown a suitcase 1. Suitcase 1 is of a type as described in my prior co-pending patent application no. GB0406156.0.

Suitcase 1 has a pivoted handle 2 which moves from a first stored position in a recess 3 to a second in use position spaced from the suitcase by a spacer 4 as described in this prior patent application. A releasable latch 5 may secure the handle 2 in the recess 3 when the handle is not in use. Handle 2 is used to push or pull the suitcase I and has a horizontal handle bar 2A.

Suitcase 1 has a pair of left and right wheels 6,7 driven respectively by motors 6A,7A powered by battery 8.

Suitcase 1 has a control apparatus 10 of the invention to control the motors 6A,7A.

Apparatus 10 has a pair of linear pressure transducers 11A,11B diametrically opposed on handle bar 2A. When handle bar 2A is pulled by a person's hand an anti-clockwise rotational force is applied to the bar handle 2A (as viewed from the right of the handle bar), and when handle bar 2A is pushed by a person's hand a clockwise rotational force is applied to bar handle 2A. Pressure transducers 11A,11B measure these anti-clockwise and clockwise rotational forces. The pressure transducers thus sense force applied to the handle pushing or pulling the article.

A pair of interconnected control units 12A,12B are connected to the pressure transducers 11A,11B. Control units 12A,12B are connected to motors 6A,7A for controlling the speed of rotation of motorised wheels 6,7 by varying the electrical power, e.g. current, supplied to the motors. Control units 12A,12B as connected to transducers 11A,11B increase the speed of rotation of motorised wheels 6,7 when the handle is pulled, and decrease the speed of rotation of motorised wheels 6,7 when the handle is pushed.

A hall sensor 13A senses the speed of rotation of left wheel 6 and is connected to the control unit 12A. Hall sensor 13B senses the speed of rotation of right wheel 7 and is connected to the control unit 12B. This allows the control units 12A,12B to be calibrated to prevent rotation of each wheel 6,7 by a motor at a speed greater than a predetermined value. This predetermined value may be set at the walking speed of a user so that the suitcase does not push or “overpower” the user.

An optional gyroscope 14 is connected to the control units 12A,12B whereby to balance the suitcase on the wheels by controlling the speed of rotation of the wheels 6,7.

A micro switch 15, which controls delivery of power from battery 8 to the control apparatus 10, is turned “on” by release of latch 8 and turns “off” when latch 8 locks handle 2 in the first position.

A hall sensor 16 is provided in handle 2 and is triggered by movement of the handle when it moves from the first position stored position to the second in use position. Once triggered, control units 12A,12B are activated and the apparatus calibrates itself ready for use.

The suitcase with the control apparatus operates as follows.

First the latch 5 is released which turns the micro switch “on” to deliver power to the control apparatus.

When the handle is moved form the first position to the second position, the hall sensor 15 allows the apparatus to calibrate itself.

If a person should start to walk and pull the handle 2 so bar 2A will be rotated clockwise. This is sensed by the transducers 11A,11B causing the control units 12A,12B to rotate the wheels 6,7 faster until the suitcase is traveling the same speed as the user. If whilst walking the person should slow down and so push the handle 2, the bar 2A will be rotated anti-clockwise. This is sensed by the transducers 11A,11B causing the control units 12A,12B to rotate the wheels 6,7 slower. The suitcase thus follows the speed of the user at just the right speed without the user having to control the speed consciously and manually.

In practice the control units 12A,12B monitor the two pressure transducers 11A,11B for rotational differences every 10 milliseconds and provides a form of pulse modulation to the drive wheels depending on the speed the user is walking.

The user will not feel the suitcase pushing against the arms in the event that the user is slowing down or the suitcase is moving down hill. As mentioned above the sensors 13A,13B and control units 12A,12B prevent the wheels from being driven above a maximum speed which means that if the user exceeds this speed the suitcase will assist but in a reduced manner.

The control units 12A,12B reduce the speed of the inside wheel as the suitcase is turned to assist turning of the suitcase. The control units 12A,12B sense through the sensors 13A,13B changes in wheel speed as the article is turned by a person with the handle, and then the control units reduces the speed of the inside wheel (based on set algorithms) as the article is turned to assist turning of the article.

When the suitcase is not in use, the handle 2 can be latched by latch 5 in its recess 3 thereby turning off the micro switch 15. This prevents the suitcase from becoming “powered”, e.g. in the hold of an aircraft.

The invention may take a form different to that specifically described above. For example the article may be other than a suitcase, e.g. a golf trolley or other trolley.

Further modifications will be apparent to those skilled in the art without departing from the scope of the present invention.

1. A control apparatus for an article with at least one motorised wheel and with a handle for pushing or pulling the article by the user, said apparatus comprising:
a) at least one transducer to sense force applied to the handle pushing or pulling the article, and
b) at least one control unit connected to the or each transducer for controlling the speed of rotation of the or each motorised wheel, the or each control unit increasing the speed of rotation of the or each motorised wheel when the handle is pulled, and the or each control unit decreasing the speed of rotation of the or each motorised wheel when the handle is pushed.

2. A control apparatus according to claim 1, wherein the or each control unit controls the amount of electrical current delivered to the or each motorised wheel.

3. A control apparatus according to claim 1, wherein the article is a suitcase or other item of luggage.

4. A control apparatus according to claim 1, wherein the control apparatus comprises at least one speed sensor to sense the speed of rotation of each wheel.

5. A control apparatus according to claim 4, wherein the or each speed sensor is connected to the or each control unit which prevents rotation of each wheel by a motor at a speed greater than a predetermined value.

6. A control apparatus according to claim 4, wherein the or each speed sensor is a hall sensor.

7. A control apparatus according to claim 1, wherein the article supports two wheels each motorised by a respective motor.

8. A control apparatus according to claim 7, wherein a control unit is provided for each wheel motor.

9. A control apparatus according to claim 7, wherein a speed sensor is provided for each control unit.

10. A control apparatus according to claim 1, wherein the control unit/s reduces the speed of the inside wheel as the article is turned to assist turning of the article.

11. A control apparatus according to claim 10, wherein the control unit/s sense through said speed sensors changes in wheel speed as the article is turned by a person with the handle, and then the control units reduce/s the speed of the inside wheel as the article is turned to assist turning of the article.

12. A control apparatus according to claim 1, wherein the article handle includes a horizontal handle bar and said at least one transducer comprises a pair of pressure transducers on said handle bar measuring rotational force applied to said handle when the article is pulled and pushed.

13. A control apparatus according to claim 1, further including a gyroscope connected to the control unit/s whereby to balance the article on the or each wheel.

14. A control apparatus according to claim 1, wherein the article comprises a handle which moves from a first stored position to a second in use position, and the apparatus further includes a movement sensor to sense when the handle moves from the first to the second position and activate the or each control unit.

15. A control apparatus according to claim 1, wherein the article comprises a handle which moves from a first stored position to a second in use position, and wherein a latch is provided to releasably lock the handle in the first position, and said latch operates a switch to prevent operation of the apparatus when the handle is locked in the second position.

16. An article comprising the control apparatus as defined in claim 1.

17. A suitcase including the control apparatus as defined in claim 1.
